(19) United States
(12) Patent Application Publication
(10) Pub. No.: US 2013/0013799 A1
(43) Pub. Date: Jan. 10, 2013

(54) METHOD AND APPARATUS FOR TRANSMITTING AND RECEIVING CONTENT IN A BROADCASTING SYSTEM

(75) Inventors: Ji-Eun Keum, Suwon-si (KR); Se-Hee HAN, Seoul (KR); Jae-Yeon Song, Seoul (KR)

(73) Assignee: Samsung Electronics Co., Ltd., Suwon-si (KR)

(21) Appl. No.: 13/543,500

(22) Filed: Jul. 6, 2012

(30) Foreign Application Priority Data
Jul. 7, 2011 (KR) 10-2011-0067529

(51) Int. Cl. G06F 15/16

(52) U.S. Cl. 709/231

(57) ABSTRACT

According to one embodiment, a method for receiving content includes a home media server that explicitly specifies a start time and an end time of each of multiple segments, and notifies the specified start times and end times to a terminal, so that the terminal may select and play the segments depending on its conditions.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Jul. 7, 2011 and assigned Serial No. 10-2011-0067529, the entire disclosure of which is incorporated herein by reference.

### TECHNICAL FIELD OF THE INVENTION

The present invention relates generally to a method and apparatus for transmitting and receiving content, and more particularly, to a method and apparatus for transmitting and receiving broadcast content in a broadcasting system.

### BACKGROUND OF THE INVENTION

Due to the recent increased use of online content, content delivery methods have been diversified such that the demand for seamless content delivery is more important than ever. Accordingly, an adaptive streaming technology has been developed in which a bit rate of content is smoothly changed during its transmission depending on the change in the variable transmission bandwidth and/or the performance of user devices that consume this content. Many standards organizations have proposed new transmission technologies in which user terminals may adaptively select and play segments of content that is divided into smaller pieces based on Hyper Text Transfer Protocol (HTTP), thus making it possible for users to enjoy content without significant delays or dropouts.

Although the conventional technology for transmitting content currently exists for adaptive streaming, there currently exists no technology for transmitting the content stored in home storage devices or content created by users to other devices by adaptive streaming. Therefore, there is a need for a method that allows external devices to play the content stored in the home storage devices by HTTP adaptive streaming.

### SUMMARY OF THE INVENTION

To address the above-discussed deficiencies of the prior art, it is a primary object to provide a method and apparatus for an external device to play content stored in home storage devices according to an HTTP adaptive streaming technique.

Another aspect of the present invention is to provide a method and apparatus for transmitting home content between home devices using Universal Plug and Play (UPnP) technology and HTTP adaptive streaming technology.

In accordance with one aspect of the present invention, a method for receiving content by a terminal in a broadcasting system includes, upon receiving content selected by user input, sending an adaptive streaming request message including object-related information to a home media server, receiving a resource property from the home media server in response to the request message, and selecting a content segment suitable for existing network conditions based on the resource property. The resource property may include at least one of identifiers (IDs) of resources of a requested object, a bit rate of each resource, segment ID information, and a start time and an end time of each segment.

In accordance with another aspect of the present invention, an apparatus for receiving content in a broadcasting system includes a transmitter configured to, upon receiving content selected by a user, send an adaptive streaming request message including object-related information to a home media server, a receiver configured to receive a resource property from the home media server in response to the request message, and a controller configured to select a content segment suitable for existing network conditions based on the resource property. The resource property may include at least one of identifiers (IDs) of resources of a requested object, a bit rate of each resource, segment ID information, and a start time and an end time of each segment.

In accordance with further another aspect of the present invention, a method for transmitting content in a broadcasting system includes, upon receiving content selected by a user, receiving an adaptive streaming request message including object-related information, from a terminal, generating streaming content in which bit rates of content indicated by the object-related information are different from each other, and generating a segment corresponding to the generated streaming, and transmitting a resource property including the segment to the terminal in response to the request message. The resource property may include at least one of identifiers (IDs) of resources of a requested object, a bit rate of each resource, segment ID information, and a start time and an end time of each segment.

In accordance with yet another aspect of the present invention, an apparatus for transmitting content in a broadcasting system includes a receiver configured to, upon receiving content selected by a user, receive an adaptive streaming request message including object-related information, from a terminal, a controller configured to generate streaming content in which bit rates of content indicated by the object-related information are different from each other, and generate a segment corresponding to the generated streaming, and a transmitter configured to transmit a resource property including the segment to the terminal in response to the request message. The resource property may include at least one of identifiers (IDs) of resources of a requested object, a bit rate of each resource, segment ID information, and a start time and an end time of each segment.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof; may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 shows an example streaming system according to an embodiment of the present invention;

FIGS. 2 and 3 show example network configuration according to an embodiment of the present invention;

FIG. 4 shows an example method for transmitting HTTP adaptive streaming according to a first embodiment of the present invention;

FIG. 5 shows an example of generating representation and segment item information included in a response that is transmitted as a result value of a CreateDASHObject( ) action according to the first embodiment of the present invention;

FIG. 6 shows an example method for transmitting HTTP adaptive streaming according to a second embodiment of the present invention;

FIG. 7 shows an example method for transmitting HTTP adaptive streaming according to a third embodiment of the present invention; and

FIG. 8 shows an example home media server and terminal according to an embodiment of the present invention.

### DETAILED DESCRIPTION OF THE INVENTION

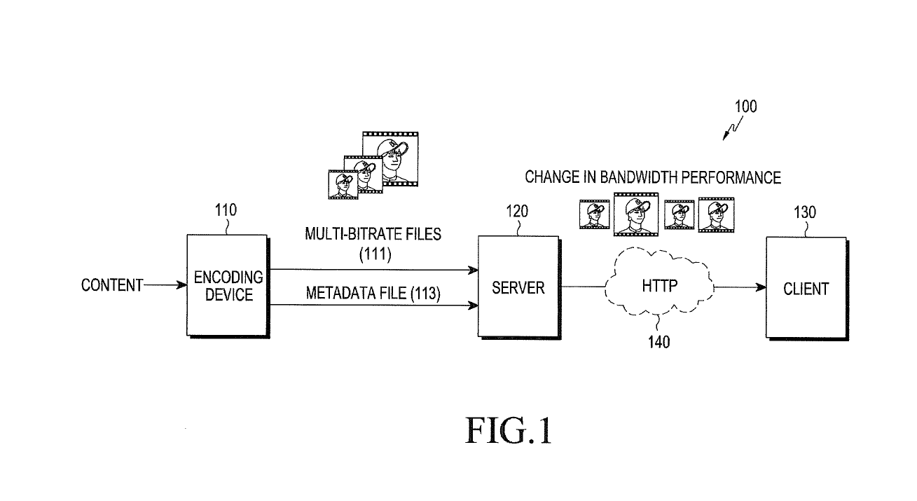

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged content broadcasting system. Exemplary embodiments of the present invention will be described in detail below with reference to the accompanying drawings. Throughout the drawings, the same drawing reference numerals will be understood to refer to the same elements, features and structures.

In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

A detailed description will be made on the typical embodiments of the present invention, presented to achieve the above-mentioned technical objectives. Although the same names as those of entities defined by 3rd Generation Partnership Project (3GPP), Moving Picture Experts Group (MPEG), Open IPTV Forum (OIPF), and Universal Plug and Play (UPnP) will be used herein for the convenience of description, it will be apparent to those skilled in the art that these standards and the names of their entities are not intended to limit the scope of the present invention, and the embodiments of the present invention may be applied to other systems with the similar technical backgrounds.

Conventionally, technology existed for transmitting content existing in service provider's servers to user devices by adaptive streaming, but no technology existed for transmitting the content stored in home storage devices or being created by users, to other devices by adaptive streaming. The present invention provides a system and method to transmit home content between home devices using UPnP technology and HTTP adaptive streaming technology. However, the present invention will not be limited to only the UPnP technology.

UPnP is one of the standards that allow devices such as Personal Computers (PCs), peripheral devices, intelligent home appliances, and wireless equipment to automatically recognize each other using Internet and web protocols when they are connected to the network. With the use of UPnP, a certain device, when it is added to the network by a user, completes the network configuration by itself, receives a TCP/IP address, and uses a discovery protocol that is based on the Internet http protocol, to inform other devices of its presence.

For the convenience of description, the terms used herein will be defined in brief.

Dynamic Adaptive Streaming over HTTP (DASH), a typical scheme of adaptive streaming, changes server-controlled adaptive streaming to client-controlled adaptive streaming. In the server-controlled adaptive streaming, a server has information about its connections to all of connected clients and generates what each client requires, thereby transmitting optimal content for each network situation. Disadvantageously, however, the server may be overloaded as the clients increase in number. In DASH, it is advantageous that the server generates in advance media segments and metadata for several possible cases and the clients request and play content depending on the situation, thus making it possible to download and play the optimal content depending on the network conditions without the load of the server.

Examples of content may include audio information, video information, audio-video information, and data. Content items may include a plurality of components as described below.

Components refer to components of a content item, such as audio information, video information, and subtitle information. For example, a component may be a subtitle stream composed in a particular language or a video stream obtained in a certain camera angle. The component may be referred to as a track or an Elementary Stream (ES) depending on its container.

Content resources refer to content items (e.g., various qualities, bit rates, and angles) which are provided in a plurality of representations to enable adaptive streaming for content items. A service discovery process may be referred to as content resources. The content resources may include one or more consecutive time periods.

A period refers to a temporal section of content resources.

Representations refer to versions (for all or some components) of content resources in a period. Representations may be different in the subset of components, or in the encoding parameters (e.g., bit rate) for components. Although representations are referred to herein as media data, they may be referred to as any terms indicating data including one or more components without being limited thereto.

A segment refers to a temporal section of representations, which is named by a unique Uniform Resource Locator (URL) in a particular system layer type (e.g., Transport Stream (TS) or Moving Picture Experts Group (MPEG)-4 (MP4) Part 14).

Example embodiments of the present invention will be described in detail below with reference to drawings.

FIG. 1 shows an example streaming system according to an embodiment of the present invention.

Referring to FIG. 1, a streaming system 100 according to an embodiment of the present invention includes an encoding device 110, a server 120, and a client 130.

The encoding device 110 generates multiple media data for single content by encoding input content in a plurality of different qualities. While the server 120 streams media data to the client 130, the streaming environment may be subject to change. For example, the bandwidth of a network 140 for streaming may be subject to change, and the hardware resources that the server 120 may use to transmit media data or the hardware resources that the client 130 may use to receive media data, may be subject to change.

Therefore, the encoding device 110 encodes single content in multiple different qualities, for adaptive streaming prepared for the variable streaming environment. Single content may be encoded in multiple different qualities by adjusting factors such as a bit rate, a sampling frequency, and/or a resolution level. For example, a plurality of media data with bit rates of 500 Kbps, 1000 Kbps and 2000 Kbps may be generated by encoding single video content in different resolutions.

The encoding device 110 transfers the plurality of media data that is encoded in different qualities to the server 120. The encoding device 110 may also transfer information about the content and information about each of the media data, to the server 120 along with the media data. Information about the content, which may be referred to as metadata associated with the content, may include information such as a content title, a content synopsis, a content identifier (ID), and a content Uniform Resource Locator (URL).

The client 130 receives at least one of the information about the content and the information about multiple media data segments, over the network 140. Based on this content, the client 130 requests at least one of the media data segments from the server 120. The client 130 estimates the streaming environment, and selects at least one of the media data segments based on the estimated streaming environment. The client 130 may select at least one media data segment that can maintain an appropriate Quality of Service (QoS) in the estimated streaming environment. Thereafter, the client 130 may send an HTTP request for requesting transmission of the selected at least one media data segment, to the server 120.

Upon receiving high-quality media data due to the degradation of the streaming environment, the client 130 requests low-quality media data among the media data segments when network conditions make seamless play of the media data difficult. In contrast, even though it may receive high-quality media data due to the improvement of the streaming environment, the client 130 may request high-quality media data among the media data segments when network conditions allow seamless play of the media data.

While receiving specific media data, the client 130 may request that the server 120 transmit other media data segments. For example, while requesting and receiving first media data segments of low quality in the degraded stream environment, the client 130 may request that the server 120 transmit second media data segments of higher quality due to an improvement of the streaming environment. In accordance with the conventional streaming method, once the server 120 and the client 130 set the quality level of the media data segments when initially setting up a streaming channel, they may continuously transmit and receive media data with the same quality level. However, in accordance with the present invention, even while receiving first media data segments have a low quality, the client 130 may request second media data segments having higher quality for the same content, thus enabling adaptive streaming depending on the streaming environment.

Various methods for estimating the streaming environment based on the bandwidth of the network 140 and the available hardware resources of the server 120 and/or the client 130 may be used by the client 130 in estimating the streaming environment. For example, the client 130 may estimate the streaming environment based on a time stamp and a Bit Error Rate (BER) of the received media data segments. The client 130 may identify a time stamp of the received media data, and determine whether the streaming environment has deteriorated, when the media data is received at a lower speed than the playback speed. The client 130 may determine that the streaming environment has deteriorated, such as when the BER of the received media data becomes high.

If the client 130 requests that the server 120 transmit at least one of the media data segments depending on the streaming environment, the server 120 transmits the requested media data to the client 130. The server 120 may transmit the requested media data to the client 130 as an HTTP response to the HTTP request.

Each of the media data segments may include at least one of a plurality of parts created by encoding and dividing content according to different qualities. In other words, each of the media data segments generated by encoding of the encoder device 110 may include at least one of the parts which are divided based on the time. The server 120 divides the media content into multiple segments and encodes and transmits them individually, rather than encoding content into one stream and continuously transmitting the encoded content. The multiple segments may be created by dividing the content in units of a predetermined time of, for example, 10 or 20 seconds. The time based on which the content is divided, may be set based on the Group of Picture (GOP). Media data corresponding to pictures in one GOP or in two or more GOPs may be set as one segment.

For example, when content is streamed in two different levels of qualities, first media data may include at least one segment that is generated by encoding content in first quality and dividing it based on the time, while second media data may include at least one segment that is generated by encoding content in second quality level and dividing it based on the time.

The above-described technique of adaptive streaming is provided by dividing each of the media data segments based on the time. For example, at the start of streaming, the server 120 transmits an segment corresponding to 0 to 20 seconds of the first media data having a low quality. Thereafter, if the client 130 requests media data having a higher quality level due to an improvement of the streaming environment after a lapse of 20 seconds, the server 120 may transmit an segment corresponding to 20 to 40 seconds of the second media data having a higher quality. The server 120 may transmit segments of different media data depending on the streaming environment during streaming, because media data is divided into multiple segments based on the time.

The present invention provides a method and apparatus for enabling network-adaptable content playback in a home environment, using a protocol defined by UPnP for the existing home environment.

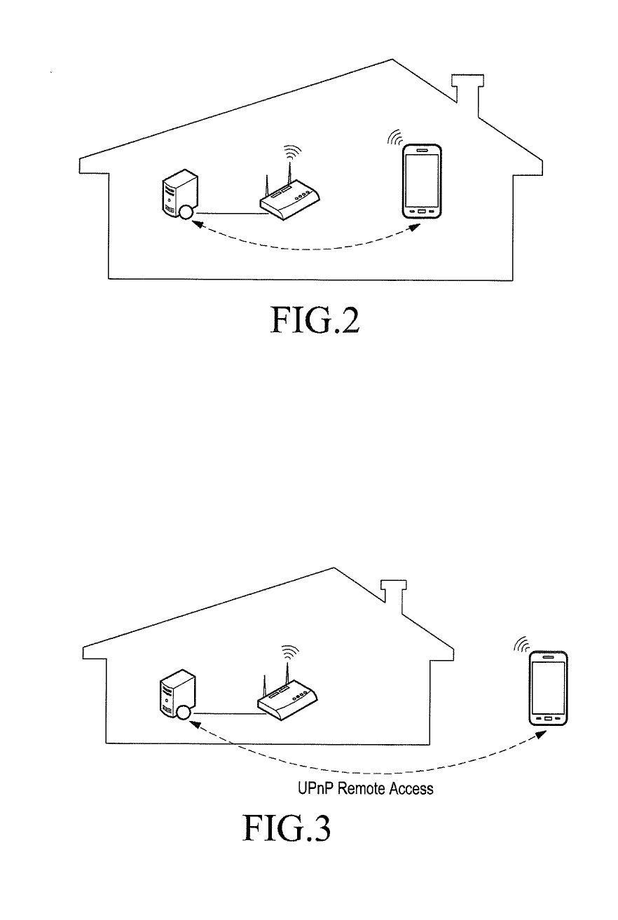

FIGS. 2 and 3 show example network configurations according to an embodiment of the present invention.

Specifically, FIG. 2 shows an example network configuration in which a terminal in a home may receive the content stored in a home media server in pieces during playback depending on the traffic conditions and/or the terminal's performance. FIG. 3 shows an example network configuration in which a terminal, when it is located outside the home, may receive the home content in pieces depending on the traffic conditions and/or the terminal's performance, using the UPnP protocol.

The terminal is assumed to be a device equipped with both a control point (CP) feature and a renderer feature of the UPnP protocol. The home media server is assumed to be a device equipped with a Digital Media Server (DMS) feature of the UPnP protocol. Therefore, the home media server may be, for example, a DMS server. Although communication and media transmission/reception between the terminal and the home media server is assumed to be achieved by the standardized UPnP technology, they are not limited thereto.

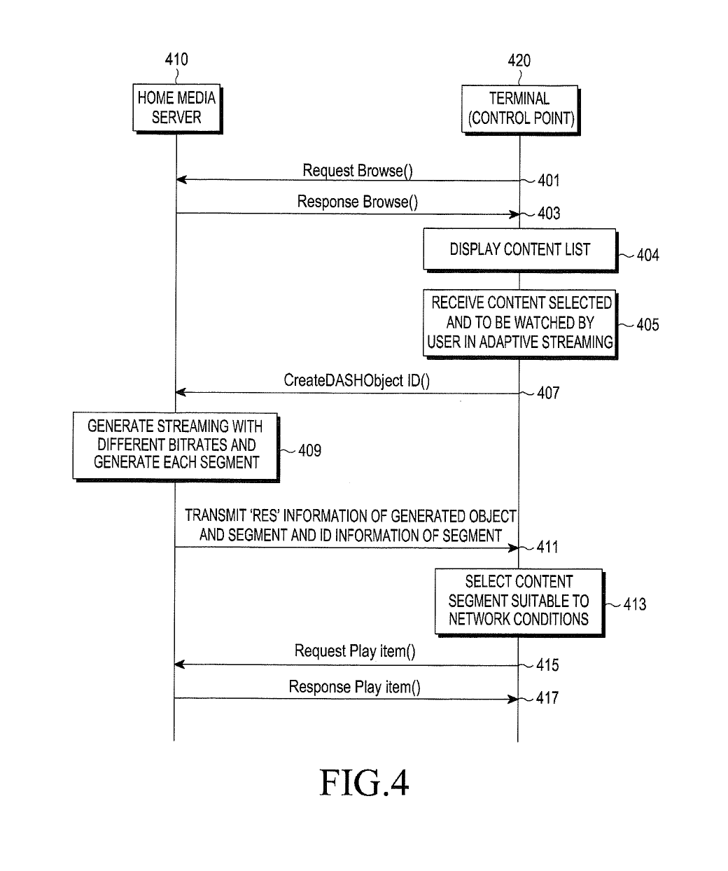

FIG. 4 shows an example method for transmitting HTTP adaptive streaming according to an embodiment of the present invention.

Reference will now be made to FIG. 4 to describe a method for transmitting HTTP adaptive streaming in an UPnP environment, according to the first embodiment of the present invention.

Upon user's request, a terminal 420 sends a request message for browsing predetermined content to a home media server 410 in step 401. Upon receiving a response message including a content list from the home media server 410 in step 403, the terminal 420 displays the content list in step 404. The user checks the content list and selects the content he or she wants to view using the adaptive streaming technique. The selected content that the user wants to view is inputted to the terminal 420 in step 405. Next, the terminal 420 sends an adaptive streaming request message including an object ID of the content that the user wants to view in an HTTP adaptive streaming environment, to the home media server 410 in step 407. Upon receiving the adaptive streaming request message, the home media server 410 generates resources (e.g., content) whose bit rates of the requested content (e.g., content indicated by object ID) are different from each other, and generates segments based on each of the resources, in step 409. Resources having different bit rates correspond to representations of the conventional adaptive streaming technology. After undergoing the operation, the home media server 410 generates a resource property representing the generated segments and provides information that a terminal may need to access each resource, to the terminal 420 in step 411. The needed information may include, for example, IDs of resources of the requested object, a bit rate of each resource, segment ID information, duration information of each segment (or a start time and an end time of each segment), and protocol information used with a resource URL of each segment. In step 413, the terminal 420 selects segments having different bit rates to be suitable for the network conditions based on the received resource information. The terminal 420 selects at least one media data segment that can maintain appropriate QoS in the estimated streaming environment.

Thereafter, in step 415, the terminal 420 designates a segment based on the protocol information used with a resource URL of a segment and requests that segment from the home media server 410 by means of a Request Play Item message. The terminal 420 should select segments such that an end time of the current segment and a start time of the next segment are contiguous. The terminal 420 may request the segment from the home media server 410 by combining URL information of an object with ID information of each segment.

In response to step 415, the home media server 410 transmits the designated segments to the terminal 420 using a Response Play Item message in step 417. In response, the terminal 420 plays the streaming.

To implement the present invention, an object (CreateDASHObject( ) given in Table 1 below should be added to the current specification.

TABLE 1
CreateDASHObject( )

| | | |
|---|---|---|
| ObjectID | IN | A_ARG_TYPE_ObjectID |
| resID | OUT | A_ARG_TYPE_ObjectID |
| SegmentstartID or segment ID | OUT | A_ARG_TYPE_ObjectID |
| Result | OUT | A_ARG_TYPE_Result |

In Table 1, object ID indicates an ID of the content that the user wants to watch in HTTP Adaptive streaming, and should be set as an input value of the createDASHObject action. Information about the resource that has encoded the content indicated by the object ID at different bit rates is included in Result as a result value of the action, and transmitted as a result value. The information associated with the resource must have res@id, res@bitrate, and res@URL.

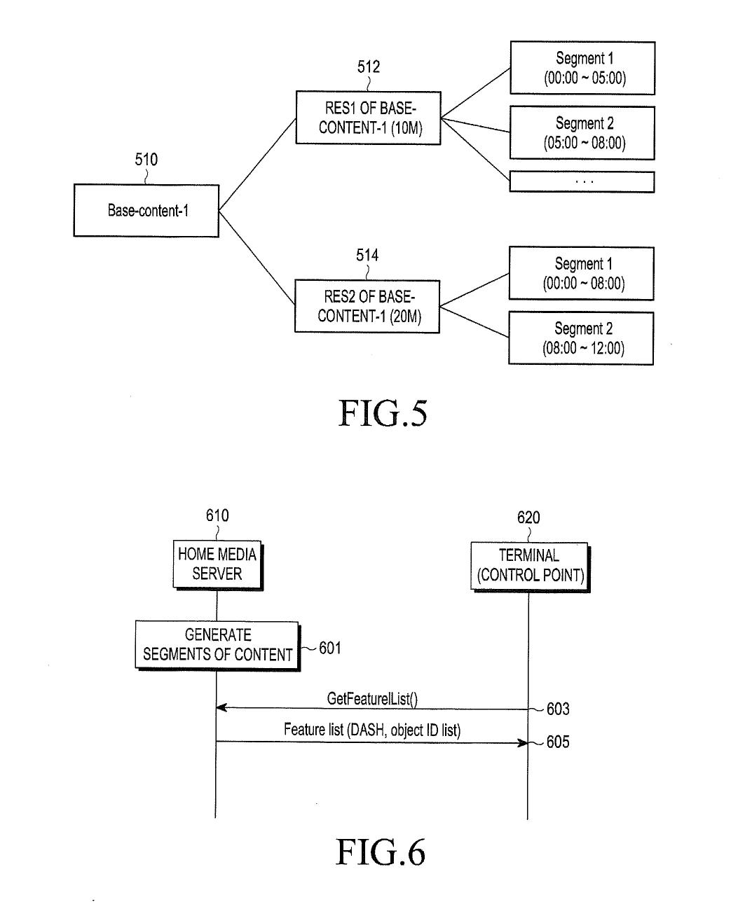

FIG. 5 shows an example of generating representation and segment item information included in a response that is actually transmitted as a result value of aCreateDASHObject( ) action according to one embodiment of the present invention. If the terminal 420 receives a request to consume an object in content called Base-content-1 510, the home media server 420 generates resources Res1 512 and Res2 514 having different bit rates of 10 Mega-bit and 20 Mega-bit for the object, and generates segments according to each resource. In an embodiment, multiple segments are generated based on Res1 having a bit rate of 10M. Segments may be contiguous with each other, having different start times and end times.

The following shows an example of representing items when streaming having bitrates of 10 Mega-bits and 20 Mega-bits are divided into 10 segments based on the example shown in FIG. 5, during its transmission. A client may switch segments having different values of baseResID, and select the next segment only when a value timerand@end of the previous segment is the same as a value of timerange@start of its succeeding segment. The following Extensible Markup Language (XML) document, which explicitly specifies a start time and an end time of each segment to provide notification to a control point of a terminal, shows an example of a list of representations and a list of segments, which are transmitted as a result value of the action.

```
<!--Representation Item -->
<item id=“base-content-1” parentID=“container-1” restricted=“0”>
    <dc:title>Shrek</dc:title>
    <upnp:class>object.item.videoItem</upnp:class>
    <res id=“base-res-1” protocolInfo=“http-get:*:video/mpeg:*”
    bitrate=“10M”>
        http://10.0.0.1/video/content?id=1
    </res>
    <res id=“base-res-2” protocolInfo=“http-get:*:video/mpeg:*”
    bitrate=“20M”>
        http://10.0.0.1/video/content?id=2
    </res>
</item>
<!-- Segment Item -->
<item id=“segment-item-1” parentID=“segment-container-1” restricted=
“0”>
    <upnp:class>object.item.videoItem</upnp:class>
        <upnp:resExt id=“segment-res-1”>
        <upnp:segmentInfo baseObjectID=“base-content-1” baseResID=
        “base-res-1”>
            <upnp:timeRange start=“00:00:00” end=“00:05:00”/>
        </upnp:segmentInfo>
    </upnp:resExt>
    <res id=“segment-res-1” protocolInfo=“http-get:*:video/mpeg:*”
    bitrate=“10M”>
        http://10.0.0.1/video/content?id=1?start=0;end=500
    </res>
</item>
<item id=“segment-item-2” parentID=“segment-container-1” restricted=
“0”>
    <upnp:class>object.item.videoItem</upnp:class>
    <upnp:resExt id=“segment-res-2”>
        <upnp:segmentInfo baseObjectID=“base-content-1” baseResID=
        “base-res-1”>
            <upnp:timeRange start=“00:05:00” end=“00:08:00”/>
        </upnp:segmentInfo>
    </upnp:resExt>
    <res id=“segment-res-2” protocolInfo=“http-get:*:video/mpeg:*”
    bitrate=“10M”>
        http://10.0.0.1/video/content?id=1?start=500;end=800
</res>
</item>
<item id=“segment-item-3” parentID=“segment-container-1” restricted=
“0”>
    <upnp:class>object.item.videoItem</upnp:class>
    <upnp:resExt id=“segment-res-3”>
        <upnp:segmentInfo baseObjectID=“base-content-1” baseResID=
        “base-res-1”>
            <upnp:timeRange start=“00:08:00” end=“00:12:00”/>
        </upnp:segmentInfo>
    </upnp:resExt>
    <res id=“segment-res-3” protocolInfo=“http-get:*:video/mpeg:*”
    bitrate=“10M”>
        http://10.0.0.1/video/content?id=1?start=800;end=1200
</res>
</item>
...
<item id=“segment-item-11” parentID=“segment-container-2” restricted=
“0”>
    <upnp:class>object.item.videoItem</upnp:class>
    <upnp:resExt id=“segment-res-11”>
        <upnp:segmentInfo baseObjectID=“base-content-1” baseResID=
        “base-res-2”>
            <upnp:timeRange start=“00:00:00” end=“00:08:00”/>
        </upnp:segmentInfo>
    </upnp:resExt>
<res id=“segment-res-11” protocolInfo=“http-get:*:video/mpeg:*” bitrate=
“20M”>
        http://10.0.0.1/video/content?id=1?start=0;end=800
</res>
</item>
<item id=“segment-item-12” parentID=“segment-container-2” restricted=
“0”>
    <upnp:class>object.item.videoItem</upnp:class>
    <upnp:resExt id=“segment-res-12>
        <upnp:segmentInfo baseObjectID=“base-content-1” baseResID=
        “base-res-2”>
            <upnp:timeRange start=“00:08:00” end=“00:12:00”/>
        </upnp:segmentInfo>
    </upnp:resExt>
    <res id=“segment-res-12” protocolInfo=“http-get:*:video/mpeg:*”
    bitrate=“20M”>
        http://10.0.0.1/video/content?id=1?start=800;end=1200
    </res>
    </item>
```

Unlike in the above example, there may be a risk that an XML file may be too large in size to specify ‘res’ property values for each of numerous segments. Therefore, when segments are listed as shown below, segment IDs may be assigned to the terminal by sequentially listing each segment ID instead of segment IDs one by one, or IDs of segments which are listed in the same interval may be may be expressed by notifying duration and a start number of a segment ID, instead of values of timerange@start and timerange@end of each segment. The following example XML document shows an appropriate example that a home media server may transmit to a terminal by notifying a duration and a start ID of a segment. This example is appropriate to actually implement a transmission XML file with reduced size.

```
<!-- Representation Item -->
<item id=“base-content-1” parentID=“container-1” restricted=“0”>
    <dc:title>Shrek</dc:title>
    <upnp:class>object.item.videoItem</upnp:class>
    <res id=“base-res-1” protocolInfo=“http-get:*:video/mpeg:*”
    bitrate=“10M”>
        http://10.0.0.1/video/content?id=1
    </res>
    <res id=“base-res-2” protocolInfo=“http-get:*:video/mpeg:*”
    bitrate=“20M”>
        http://10.0.0.1/video/content?id=2
    </res>
</item>
<!-- Segment Item -->
<item id=“segment-item-1” parentID=“segment-container-1” restricted=
“0”>
    <upnp:class>object.item.videoItem</upnp:class>
        <upnp:resExt startId=“1”>
        <upnp:segmentInfo baseObjectID=“base-content-1” baseResID=
        “base-res-1”>
            <upnp:timeRange duration=”05:00”>
    <upnp:resExt startId=“11”>
        <upnp:segmentInfo baseObjectID=“base-content-1” baseResID=
        “base-res-2”>
            <upnp:timeRange duration=“05:00”>
    <res id=“segment-res-1” protocolInfo=“http-get:*:video/mpeg:*”
    bitrate=“10M”>
        http://10.0.0.1/video/content?id=1?duration=500
    </res>
    <res id=“segment-res-11” protocolInfo=“http-get:*:video/mpeg:*”
    bitrate=“20M”>>
        http://10.0.0.1/video/content?id=2?duration=500
    </res>
    </item>
```

For above example, a property for duration and startIndex should be added to the current specification as follows.

upnp:resExt@segmentStartId

Namespace: upnp Property Data Type: xsd:string Multi-Valued: NO
Description: This property is a REQUIRED property of the associated upnp:segmentID property. It indicates the starting number of the segment identifier. So the segment ID can be derived from segmentstartID and this timeRange@duration value at the control point. The segment Id is assigned contiguously from this value.

upnp:resExt::segmentInfo::timeRange@duration

Namespace: upnp Property Data Type: xsd:string Multi-Valued: NO
Description: This property is a REQUIRED property of the associated upnp:resExt::segmentInfo::timeRange property. It indicates the duration of the time range for the segment. The contiguous segment has the same duration. The format of this property MUST comply with the time syntax as defined in Appendix D, “EBNF Syntax Definitions”. The upnp:timeRange values are measured relative to the base content with 00:00:00 indicating the start of the base content.

FIG. 6 shows an example method for transmitting HTTP adaptive streaming content according to an embodiment of the present invention.

If a terminal 620 and a home media server 610 include the features which are based on the adaptive streaming technology standardized in existing 3GPP, MPEG, or OIPF, then the terminal 620 may analyze Media Presentation Descriptor (MPD) files meeting the specifications, and the home media server 610 may generate MPD. Therefore, if the terminal 420 requests adaptive streaming for specific content in FIG. 4, the position where MPD actually exists may be notified as its result value as follows in FIG. 6. In this case, new information indicating the position where MPD exists should be transmitted.

```
<item id=“base-content-1” parentID=“container-1” restricted=“0”>
    <dc:title>Shrek</dc:title>
    <upnp:class>object.item.videoItem</upnp:class>
    <res id=“base-res-1” protocolInfo=“http-get:*:video/mpeg:*”
    extlinkURI=“>
        http://10.0.0.1/video/content?id=1
    </res>
</item>
```

res@extlinkURI

Namespace: DIDL-Lite Property Data Type: xsd:anyURI Multi-Valued: NO
Description: Each res@extlink property contains a URI employed to assist the control point in providing additional information to the user about the content referenced by the resource. The value of this property refers to an xml page and a web site associated.
Default Value None.

When accessing the terminal 620, the home media server 610 may have already generated segments of content in step 601. In this case, the terminal 620 requests an ID of an object of content whose related segments have already been generated, from the home media server 610, using an action call GetFeatureList( ), in step 603. Then, the home media server 610 transmits a feature list including DASH and object ID list to the terminal 620 in step 605.

Table 2 below shows the feature that should be added in the feature list.

TABLE 2

| Name | Description |
|---|---|
| DASH | HTTP Adaptive Streaming |

Upon receiving the feature list in step 605 through the above example, the terminal 620 may determine whether the home media server 610 supports network-adaptive streaming services, and which content is prepared in the home media server 610, for adaptive streaming.

The following XML document shows an example of an XML document by which the home media server 610 actually transmits the feature for DASH to the terminal 620.

```
<?xml version=“1.0” encoding=“UTF-8”?>
<Features
  xmlns=“urn:schemas-upnp-org:av:avs”
  xmlns:xsi=“http://www.w3.org/2001/XMLSchema-instance”
  xsi:schemaLocation=“
    urn:schemas-upnp-org:av:avs
      http://www.upnp.org/schemas/av/avs.xsd”>
    <Feature name=“DASH” version=“1”>
        <objectIDs>base_content1, base_content2 </objectIDs>
    </Feature>
      </Features>
```

In the case of live content, the content needs to be updated at regular intervals while segments are continuously generated. In addition, the content is updated when the server re-generates segments, or when resource information of segments changes. The following example corresponds to an example where segment information is updated.

If a ‘Minupdatetime’ attribute exists, related content refers to the content that is generated and stored live or presently. Therefore, a new segment is generated and its associated information is also generated. Accordingly, the control point should continuously undergo a process of requesting and receiving segment information from the home media server.

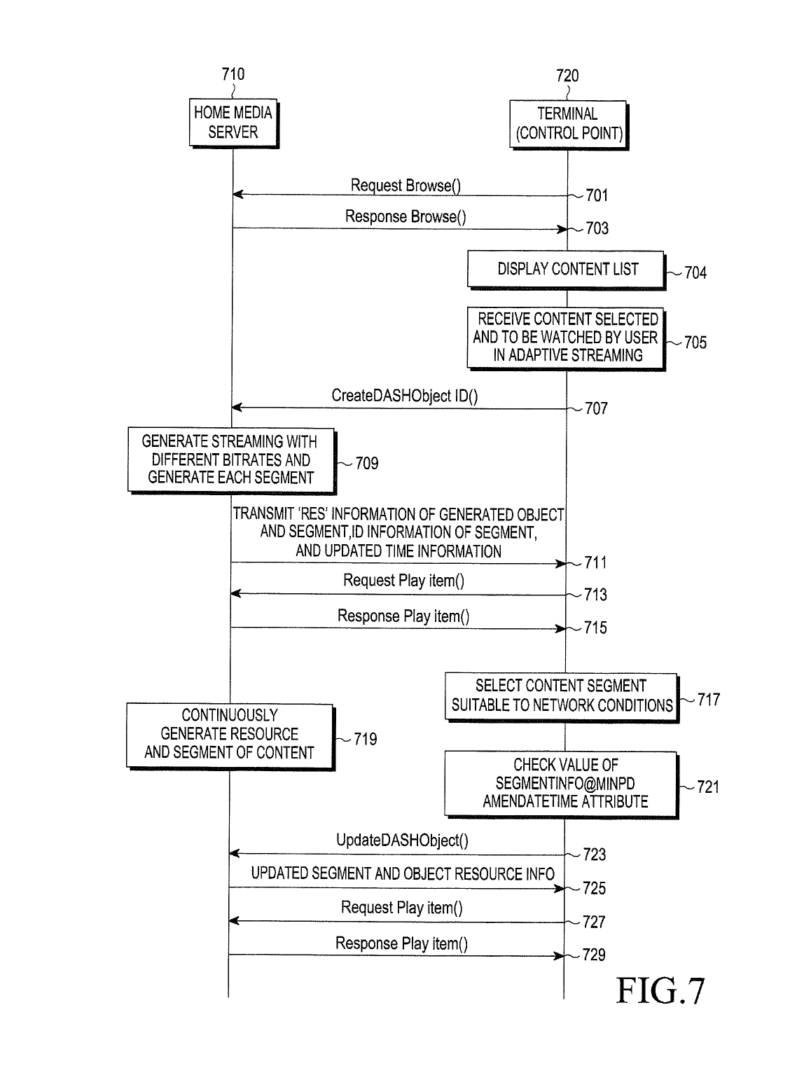

FIG. 7 shows an example method for transmitting HTTP adaptive streaming content according to an embodiment of the present invention.

This embodiment proposes a method for updating information about continuously generated segments. Steps 401 to 409 in FIG. 4 are the same as steps 701 to 709 in FIG. 7 in operation, so a detailed description thereof will be omitted.

Although step 711 in FIG. 7 is similar in operation to step 411 in FIG. 4, in addition to an operation in step 411, an operation in step 711 is further characterized in that a home media server 710 transmits time information indicating when a terminal 720 will request updated information from the home media server 710, to the terminal 720 using a response to a DASHCreateObject action. In steps 713 and 715, the terminal 720 requests and receives an item to be updated, from the home media server 710. In step 717, the terminal 720 selects segments having different bit rates suitable to the network conditions based on the received resource information. The terminal 720 checks the time information in step 721, and transmits an updateDASHObject( ) action for segment information update after a lapse of the time, in step 723. Before step 723, the home media server 710 continuously generates content and resource segments in step 719.

Table 3 below describes an action that is provided in order for a client to update segment information. In other words, Table 3 describes information added to updateDASHObject( ).

TABLE 3
updateDASHObject( )

| Argument | Direction | Related State Variable |
|---|---|---|
| ObjectID | IN | A_ARG_TYPE_ObjectID |
| resID | OUT | A_ARG_TYPE_ObjectID |
| SegmentstartID or segment ID | OUT | A_ARG_TYPE_ObjectID |
| Result | OUT | A_ARG_TYPE_Result |

The following is a definition of a needed property.

upnp:resExt::segmentInfo::minupdatetime
Namespace: upnp Property Data Type: xsd:string Multi-Valued: NO
Description: This property identifies a minimum time before updating the resource information of the indicated object and segment Info.

After a lapse of a minimum of minupdatetime, the terminal 720 requests segment information from the home media server 710. In other words, the home media server 710 generates update information to be transferred to the terminal 720 before a lapse of minupdatetime.

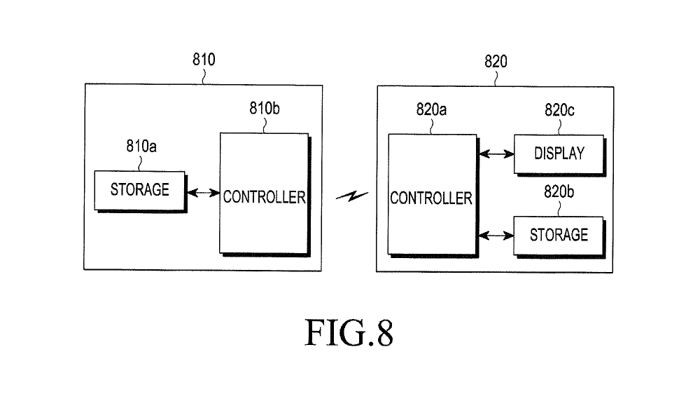

FIG. 8 illustrates an example home media server and terminal according to an embodiment of the present invention.

Referring to FIG. 8, a home media server 810 includes a storage 810a and a controller 810b, and a terminal 820 includes a controller 820a, a display 820c, and a storage 820b. The home media server 810 and the terminal 820 may include more components, but they will be omitted herein for simplicity.

The storage 810a in the home media server 810 stores resources and segments of generated content.

The controller 810b in the home media server 810 controls the home media server 810 to perform the server operation as described in FIGS. 4 to 7. The controller 820a in the terminal 820 controls the terminal 820 to perform the terminal operation as described in FIGS. 4 to 7.

The storage 820b is connected to the controller 820a, and includes a Read Only Memory (ROM), a Random Access Memory (RAM) and a voice memory for storing multiple programs and information used for controlling operation of the terminal 820.

The display 820c in the terminal 820, under control of the controller 820a, displays a screen on which the user may select the content he or she wants to watch in adaptive streaming.

As is apparent from the foregoing description, according to exemplary embodiments of the present invention, a home media server may explicitly specify a start time and an end time of each segment to notify them to a terminal, so the terminal may select and play content depending on its conditions.

In addition, the present invention may prevent a terminal from suffering from delay or loss of content.

Besides, the present invention may allow external terminals to play the content stored in home storage devices by HTTP adaptive streaming.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for receiving content by a terminal in a broadcasting system, comprising:
upon receiving content that has been selected by a user, sending an adaptive streaming request message including object-related information to a home media server;
receiving a resource property from the home media server in response to the request message; and
selecting a content segment suitable to network conditions based on the resource property,
wherein the resource property includes at least one of identifiers (IDs) associated with resources of a requested object, a bit rate of each resource, segment ID information, and a start time and an end time of each segment.

2. The method of claim 1, wherein the resource property includes updated time information.

3. The method of claim 1, wherein the resource property includes duration information and a segment start ID.

4. The method of claim 1, wherein the resource property includes protocol information used with a resource Uniform Resource Locator (URL) of each segment.

5. The method of claim 2, further comprising:
determining minimum update time information based on the updated time information;
sending an updated adaptive streaming request message including object-related information to the home media server; and
receiving updated segment and object-related information from the home media server in response to the updated adaptive streaming request message.

6. An apparatus configured to receive content in a broadcasting system, the apparatus comprising:
a transmitter configured to, upon receiving content selected by a user, send an adaptive streaming request message including object-related information to a home media server;
a receiver configured to receive a resource property from the home media server in response to the request message; and
a controller configured to select a content segment suitable to network conditions based on the resource property;
wherein the resource property includes at least one of identifiers (IDs) of resources of a requested object, a bit rate of each resource, segment ID information, and a start time and an end time of each segment.

7. The apparatus of claim 6, wherein the resource property includes updated time information.

8. The apparatus of claim 6, wherein the resource property includes duration information and a segment start ID.

9. The apparatus of claim 6, wherein the resource property includes protocol information used with a resource Uniform Resource Locator (URL) of each segment.

10. The apparatus of claim 7, wherein:
the controller is configured to determine minimum update time information based on the updated time information;
the transmitter is configured to send an updated adaptive streaming request message including object-related information to the home media server; and
the receiver is configured to update segment and object-related information from the home media server in response to the updated adaptive streaming request message.

11. A method for transmitting content in a broadcasting system, the method comprising:
upon receiving content selected by a user, receiving an adaptive streaming request message including object-related information, from a terminal;
generating streaming content in which bit rates of content indicated by the object-related information are different from each other, and generating a segment corresponding to the generated streaming content; and
transmitting a resource property including the segment to the terminal in response to the request message;
wherein the resource property includes at least one of identifiers (IDs) of resources of a requested object, a bitrate of each resource, segment ID information, and a start time and an end time of each segment.

12. The method of claim 11, wherein the resource property includes updated time information.

13. The method of claim 11, wherein the resource property includes duration information and a segment start ID.

14. The method of claim 11, wherein the resource property includes protocol information used with a resource Uniform Resource Locator (URL) of each segment.

15. The method of claim 12, further comprising:
receiving an updated adaptive streaming request message including object-related information from the terminal; and
transmitting updated segment and object-related information to the terminal in response to the updated adaptive streaming request message.

16. An apparatus configured to transmit content in a broadcasting system, the apparatus comprising:
a receiver configured to, upon receiving content selected by a user, receive an adaptive streaming request message including object-related information, from a terminal;
a controller configured to generate streaming content in which bit rates of content indicated by the object-related information are different from each other, and generate a segment corresponding to the generated streaming; and
a transmitter configured to transmit a resource property including the segment to the terminal in response to the request message;
wherein the resource property includes at least one of identifiers (IDs) of resources of a requested object, a bit rate of each resource, segment ID information, and a start time and an end time of each segment.

17. The apparatus of claim 16, wherein the resource property includes updated time information.

18. The apparatus of claim 16, wherein the resource property includes duration information and a segment start ID.

19. The apparatus of claim 16, wherein the resource property includes protocol information used with a resource Uniform Resource Locator (URL) of each segment.

20. The apparatus of claim 17, wherein:
the receiver is configured to receive an updated adaptive streaming request message including object-related information, from the terminal; and
the transmitter is configured to transmit updated segment and object-related information to the terminal in response to the updated adaptive streaming request message.
